(19) United States
(12) Patent Application Publication
(10) Pub. No.: US 2009/0292602 A1
(43) Pub. Date: Nov. 26, 2009

(54) METHODS, DEVICES, SYSTEMS, AND COMPUTER PROGRAM PRODUCTS FOR DISTRIBUTING ELECTRONIC COUPONS

(75) Inventor: Akbar Pirani, Marietta, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC., Wilmington, DE (US)

(21) Appl. No.: 12/125,317

(22) Filed: May 22, 2008

(51) Int. Cl. G06Q 30/00

(52) U.S. Cl. 705/14.17

(57) ABSTRACT

Electronic coupons are distributed by receiving customer preferences including a customer identifier associated with a preferred vendor identifier, a preferred vendor category identifier, a preferred product/service identifier, or a preferred brand name identifier. Vendor information is received which includes a vendor identifier, a vendor category identifier, a vendor product/service identifier, a brand name identifier, or a promotional offer discount parameter. The customer preferences are compared with the vendor information to determine whether or not a match exists between the customer preferences and the vendor information. If a match exists, an electronic coupon is generated that includes information indicative of the preferred vendor identifier, the preferred vendor category identifier, the preferred product/service identifier, the preferred brand name identifier, or the promotional offer discount parameter. The generated electronic coupon is distributed to a customer associated with the customer identifier.

### BACKGROUND

Exemplary embodiments relate generally to electronic coupons and, more particularly, to methods, devices, systems, and computer program products for distributing electronic coupons based upon customer preferences and/or other predetermined criteria.

At present, paper coupons are in widespread use throughout many point-of-sale environments. Coupons are distributed to consumers by mail, stacked in store displays, handed out by cashiers, inserted into newspapers and magazines, or printed in conjunction with cash register receipts. In addition to providing customers with a means of saving money, coupons are also advantageous in that they provide manufacturers and vendors with a vehicle for promoting products and services.

The process of distributing, acquiring, and redeeming paper coupons is very inefficient. It has been estimated that 248 billion coupons are distributed annually. Of this staggering number, a paltry 1.8% is redeemed. The remaining 98.2% go to waste. For example, consumers may spend a significant amount of time scanning various advertising leaflets in the Sunday newspaper yet only clip two or three coupons of interest. The remaining portions of these advertising leaflets are discarded, adding large volumes of unnecessary waste to public landfills. From an ecological perspective, many trees must be sacrificed in order to produce these leaflets. Meanwhile, the redemption of coupons leads to inconvenience for consumers as well as merchants. At point of sale terminals, customers may become frustrated as they wait behind individuals rummaging through thick stacks of paper coupons. Checkout clerks may become frustrated as they attempt to verify that the customer has, indeed, purchased the item or items specified by each coupon the customer seeks to redeem.

More recently, coupons have been made available over the Internet. Upon viewing a particular product on a personal computer, laptop computer, or personal digital assistant (PDA), the consumer is informed that a coupon may be printed and redeemed in order to obtain a particular discount or incentive. It is estimated that coupons which are downloaded over the Internet and then printed are redeemed at a rate of 65%. Nevertheless, this approach still involves considerable waste for the coupons that are not redeemed. Even the redeemed coupons are printed on paper which is ultimately discarded. From a practical standpoint, coupons distributed over the Internet have a relatively limited exposure to consumers, as contrasted with more traditional distribution methods such as newspaper and magazine inserts. Whereas consumers may receive paper advertising inserts without explicitly requesting them, formulating an appropriate Internet search query is generally required if one wishes to obtain online coupons for products of interest. Accordingly, if a vendor promotes a product or a service exclusively by means of Internet coupons, many consumers who might be interested in the product are not reached.

In view of the aforementioned shortcomings, it would be desirable to formulate a fast, efficient, and convenient method for distributing coupons.

### BRIEF SUMMARY

Exemplary embodiments relate to methods of distributing electronic coupons. These methods comprise receiving customer preferences including a customer identifier associated with at least one of a preferred vendor identifier, a preferred vendor category identifier, a preferred product/service identifier, or a preferred brand name identifier. Vendor information is received which includes at least one of a vendor identifier, a vendor category identifier, a vendor product/service identifier, a brand name identifier, or a promotional offer discount parameter. The customer preferences are compared with the vendor information to determine whether or not a match exists between the customer preferences and the vendor information. If a match exists, an electronic coupon is generated that includes information indicative of at least one of the preferred vendor identifier, the preferred vendor category identifier, the preferred product/service identifier, the preferred brand name identifier, or the promotional offer discount parameter.

Additional exemplary embodiments include computer program products comprising a storage medium readable by a processing circuit and storing instructions for execution by the processing circuit for facilitating methods of distributing electronic coupons. The methods comprise receiving customer preferences including a customer identifier associated with at least one of a preferred vendor identifier, a preferred vendor category identifier, a preferred product/service identifier, or a preferred brand name identifier. Vendor information is received which includes at least one of a vendor identifier, a vendor category identifier, a vendor product/service identifier, a brand name identifier, or a promotional offer discount parameter. The customer preferences are compared with the vendor information to determine whether or not a match exists between the customer preferences and the vendor information. If a match exists, an electronic coupon is generated that includes information indicative of at least one of the preferred vendor identifier, the preferred vendor category identifier, the preferred product/service identifier, the preferred brand name identifier, or the promotional offer discount parameter.

Additional exemplary embodiments include a device for receiving electronic coupons. The device includes an input mechanism for specifying customer preferences including at least one of a preferred vendor identifier, a preferred vendor category identifier, a preferred product/service identifier, or a preferred brand name identifier. The device also includes a communications mechanism, operatively coupled to the input mechanism, for transmitting the specified customer preferences to a communications network, and for receiving at least one electronic coupon from the communications network, the electronic coupon including at least one of the preferred vendor identifier, the preferred vendor category identifier, the preferred brand name identifier, or a promotional offer discount parameter. The device also includes an output mechanism, operatively coupled to the communications mechanism, for performing at least one of: (a) storing the electronic coupon in a computer-readable storage medium, (b) electronically displaying information indicative of at least one of the preferred vendor identifier, the preferred vendor category identifier, the preferred brand name identifier, or the promotional offer discount parameter, (c) outputting the electronic coupon to a data communications port, (d) generating a printout indicative of at least one of the preferred vendor identifier, the preferred vendor category identifier, the preferred brand name identifier, or the promotional offer discount parameter, (e) transmitting the electronic coupon to a vendor if the customer has registered with the vendor, or (f) purchasing a product or a service electronically from the vendor using the electronic coupon.

Additional exemplary embodiments include a system for distributing electronic coupons. The system includes a receiving mechanism for receiving customer preferences including a customer identifier associated with at least one of a preferred vendor identifier, a preferred vendor category identifier, a preferred product/service identifier, or a preferred brand name identifier. The receiving mechanism is also capable of receiving vendor information including at least one of a vendor identifier, a vendor category identifier, a vendor product/service identifier, a brand name identifier, or a promotional offer discount parameter. The system also includes a processing mechanism capable of comparing the customer preferences with the vendor information to determine whether or not a match exists between the customer preferences and the vendor information. If a match exists, the processing mechanism generates an electronic coupon including information indicative of at least one of the preferred vendor identifier, the preferred vendor category identifier, the preferred product/service identifier, the preferred brand name identifier, or the promotional offer discount parameter.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of an exemplary system that may be utilized for distributing electronic coupons.

FIG. 2 is a data structure diagram showing an exemplary customer preferences table for use with the system of FIG. 1.

FIG. 3 is a data structure diagram showing an exemplary vendor information table for use with the system of FIG. 1.

FIG. 4 is a data structure diagram showing an exemplary electronic coupons table for use with the system of FIG. 1.

FIGS. 5A-5D together comprise a flow diagram of an exemplary process for distributing electronic coupons.

FIG. 6 is a flow diagram of an exemplary process for receiving, storing, and redeeming electronic coupons.

The detailed description explains the exemplary embodiments, together with advantages and features, by way of example with reference to the drawings.

### DETAILED DESCRIPTION OF EXEMPLARY EMBODIMENTS

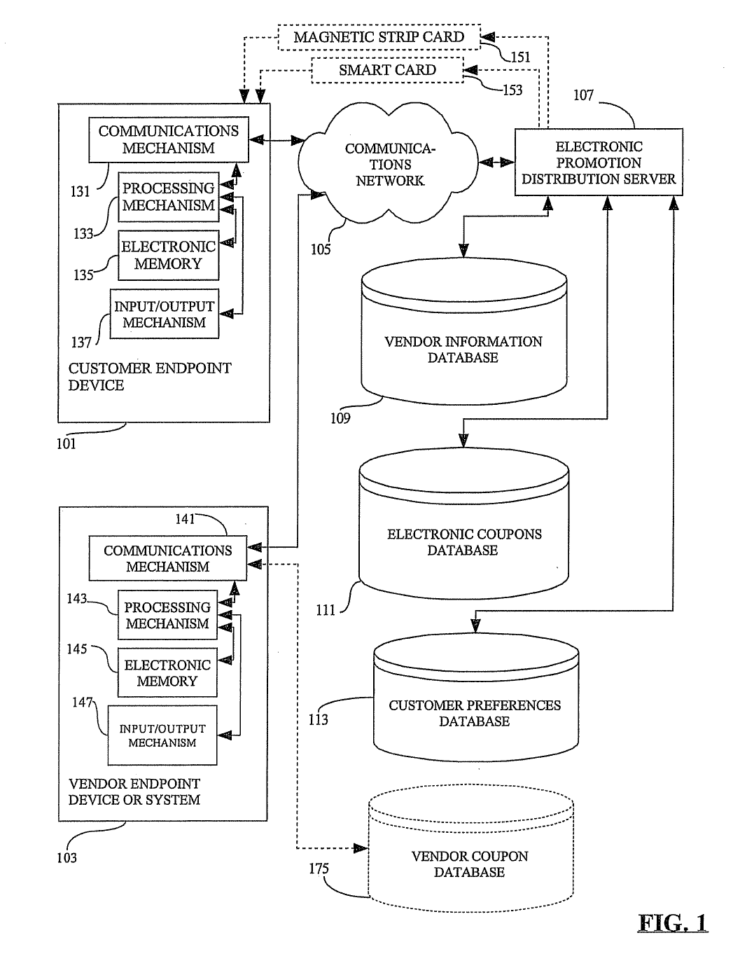

FIG. 1 is a block diagram of an exemplary system that may be utilized for distributing electronic coupons. Communications network 105 is illustratively implemented using the Internet, a private intranet, a public switched telephone network (PSTN), a cable television network, a neural network, one or more other types of networks, or any of various combinations thereof Customer endpoint device 101 represents any device that includes a processing mechanism 133 operatively coupled to an electronic memory 135, an input/output mechanism 137 operatively coupled to processing mechanism 133, and a communications mechanism 131 capable of initiating electronic communication over communications network 105. Processing mechanism 133 is capable of storing data in electronic memory 135, and is also capable of retrieving data from electronic memory 135. The specific architecture employed for customer endpoint device 101 is illustrative in nature, it being clearly understood that other architectures could be employed instead of, or in addition to, the architecture shown in FIG. 1.

Electronic memory 135 is capable of storing electronic coupons in the form of coupon data setting forth at least one of: (a) graphical display data for electronically displaying a predetermined coupon on input/output mechanism 137, (b) bar code display data for electronically displaying a predetermined bar code on input/output mechanism 137, (c) print data for printing a coupon using input/output mechanism 137 or a printer connected to input/output mechanism 137, or (d) identification data for identifying one or more predetermined coupons by means of any of the following: (i) a brand name identifier, (ii) a product/service identifier, (iii) a product SKU number, (iv) a vendor identifier, (iv) a vendor category identifier, or (v) a graphical icon indicative of the brand name identifier, product/service identifier, vendor identifier, or vendor category identifier.

A brand name identifier may include alphabetic or alphanumeric characters corresponding to a specific product or service brand name, such as “Captain Crunch™ Cereal”. A product/service identifier may include alphabetic or alphanumeric characters corresponding to a type of product or service, such as “breakfast cereal” or “food products”. A graphical icon may include, for example, a graphical representation of a cereal box, optionally including a specific alphabetic or alphanumeric product code associated therewith.

Input/output mechanism 137 is capable of generating a humanly discernible output in response to a signal received from processing mechanism 133, and is also capable of generating an electronic signal for receipt by processing mechanism 133 in response to a user input. Input/output mechanism 137 can be implemented using a single integrated device, such as a touch-sensitive display screen, or using two or more separate devices such as a keyboard and a liquid crystal diode (LCD) display screen. Illustratively, input/output mechanism 137 includes one or more keys or buttons, a touch screen, a mouse, a stylus, or another device that converts mechanical energy into an electrical signal. Optionally, input/output mechanism 137 includes a printing mechanism or a printer data port to which an external printer may be connected.

Optionally, input/output mechanism 137 is capable of accepting a display command indicating that a user wishes to electronically display one or more stored electronic coupons on a display screen. In response to the display command, processing mechanism 133 retrieves display data corresponding to one or more stored electronic coupons from electronic memory 135, and provides the retrieved display data to a display controlling circuit, so as to cause a visual display on a display screen of input/output mechanism 137 of one or more electronic coupons stored in electronic memory 135.

Pursuant to another optional feature, processing mechanism 133 retrieves bar code display data corresponding to one or more stored electronic coupons for electronically displaying a predetermined bar code on a display screen of input/output mechanism 137, and provides the retrieved bar code display data to the display controlling circuit of input/output mechanism 137, so as to cause a visual display on the display screen of one or more bar codes corresponding to electronic coupons stored in electronic memory. Pursuant to yet another optional feature, processing mechanism 133 retrieves identification data corresponding to one or more stored electronic coupons for electronically displaying identification data on input/output mechanism 137 including any of (a) a product or service category, or (b) a product or service brand name. Pursuant to still another optional feature, if a plurality of electronic coupons are stored in electronic memory 135, each of the plurality of electronic coupons (or bar codes, or identification information, or any combination of bar codes, identification information, and coupons) may be displayed on input/output mechanism 137 in a sequential manner, one after another. Alternatively, two or more stored electronic coupons may be displayed simultaneously on input/output mechanism 137.

Pursuant to an alternate embodiment, input/output mechanism 137 includes a port capable of communicating with a smart card reader/writer so as to implement storing/writing of electronic coupons as well as reading/retrieving of electronic coupons. In the case of storing/writing electronic coupons, input/output mechanism 137 outputs electronic data corresponding to one or more coupons to the smart card reader/writer. When a smart card is placed proximate to the smart card reader/writer (i.e., by sweeping the smart card through the reader/writer or inserting the smart card into the reader/writer), the electronic data corresponding to the one or more coupons is stored in a memory device of the smart card for subsequent use as an electronic coupon. Alternatively or additionally, electronic coupons could be stored on magnetic strip cards with the smart card reader/writer being replaced or supplanted by a magnetic strip reader/writer. Alternatively or additionally, the smart card reader/writer or magnetic strip reader/writer may be integrated into input/output mechanism 137.

The reading/retrieving of coupons stored on smart cards is performed by customer endpoint device 101, or by a smart card reader at a merchant, or both. In the case of customer endpoint device 101, electronic data corresponding to one or more stored coupons is retrieved from the memory device of the smart card by the smart card reader/writer and received by input /output mechanism 137. Processing mechanism 133 then processes the received electronic data to cause one or more stored coupons to be displayed on an electronic display mechanism included in input/output mechanism 137, or to be printed out on a printing mechanism associated with customer endpoint device 101, or both. The displayed or printed coupon can then be presented to the merchant for redemption. Alternatively or additionally, the smart card or magnetic strip on which the one or more electronic coupons are stored may be presented to a merchant, whereupon the merchant scans the smart card or magnetic strip using a smart card reader or magnetic strip reader. Optionally, the smart card processor on which one or more electronic coupons are stored is equipped with a timer, such that coupon data corresponding to a given coupon will not be transmitted to the smart card reader after expiration of a predetermined time period representing the expiration date of the coupon.

Illustrative examples for customer endpoint device 101 include a television set, a personal computer, a laptop computer, a personal digital assistant (PDA), a wireless telephone, an Ethernet-enabled device, a WiFi-enabled device, a media presentation device, a device equipped to receive internet protocol television (IPTV) programs, a microprocessor-based device, or the like.

Vendor endpoint device or system 103 represents any device or system that includes a processing mechanism 143 operatively coupled to an electronic memory 145, an input/output mechanism 147 operatively coupled to processing mechanism 143, and a communications mechanism 141 capable of initiating electronic communication over communications network 105. Processing mechanism 141 is capable of storing coupon data in electronic memory 145, and is also capable of retrieving coupon data from electronic memory 145. Input/output mechanism 147 is capable of generating a humanly discernible output in response to an electronic signal received from processing mechanism 143, and is also capable of generating an electronic signal for receipt by processing mechanism 143 in response to a user input. As previously described in connection with customer endpoint device 101, input/output mechanism 147 of vendor endpoint device or system 103 can be implemented using a single integrated device, such as a touch-sensitive display screen, or using two or more separate devices such as a keyboard and a liquid crystal diode (LCD) display screen. Illustrative examples for vendor endpoint device or system 103 include a mainframe computer, a television set, a personal computer, a laptop computer, a personal digital assistant (PDA), a network of computers, a wireless telephone, an Ethernet-enabled device, a WiFi-enabled device, a media presentation device, a microprocessor-based device, or the like. A vendor endpoint device or system 103 may optionally use a vendor coupon database 175 to retrieve coupon information, and also to send coupon information to electronic promotion distribution server 107. The specific architecture employed for vendor endpoint device or system 103 is illustrative in nature, it being clearly understood that other architectures could be employed instead of, or in addition to, the architecture shown in FIG. 1.

Electronic promotion distribution server 107 represents any system that includes a processing mechanism capable of storing coupon data on, and retrieving coupon data from, one or more databases. Illustratively, these databases include vendor information database 109, electronic coupons database 111, and customer preferences database 113. Electronic promotion distribution server 107 also includes a communications mechanism capable of initiating electronic communication over communications network 105. Illustrative examples for electronic promotion distribution server 107 include a mainframe computer, a personal computer, a laptop computer, a network of computers, one or more PDAs, an Ethernet-enabled device, a WiFi-enabled device, a microprocessor-based device, a group of microprocessor-based devices, or the like.

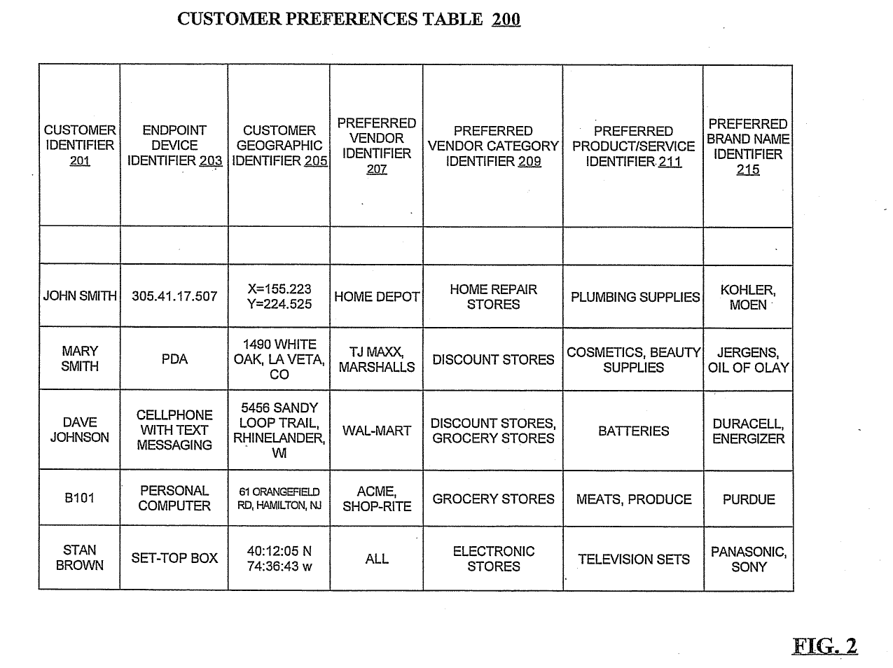

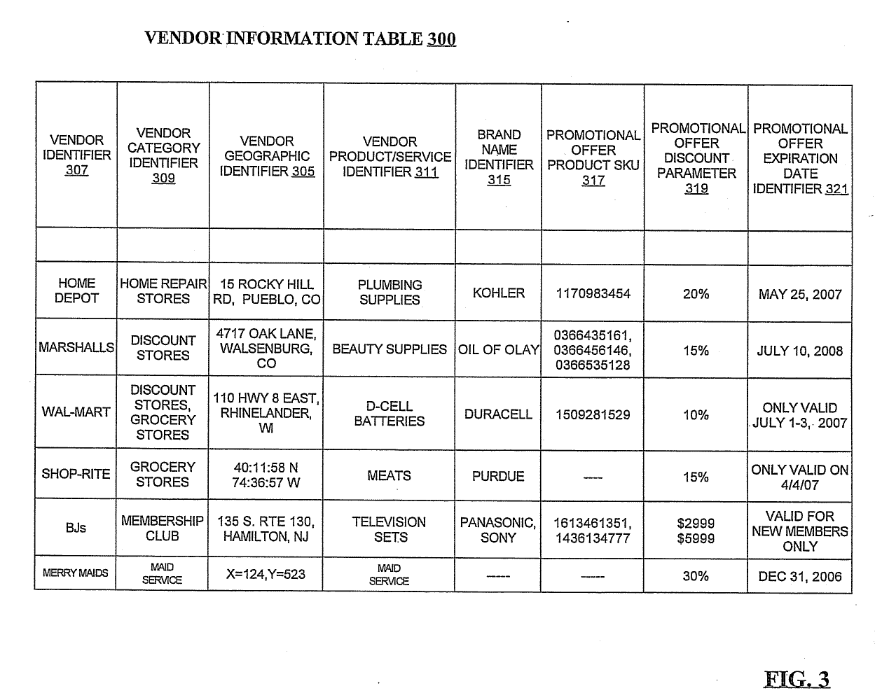

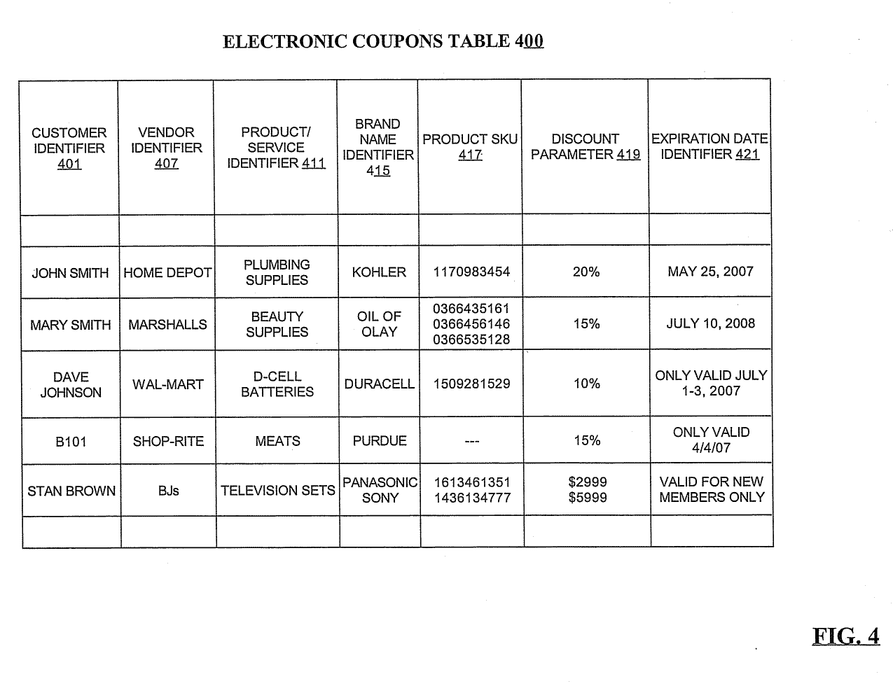

Electronic promotion distribution server 107 maintains one or more databases that include customer preferences, vendor information, and electronic coupons. Illustratively, these databases are provided in the form of a vendor information database 109, a customer preferences database 113, and an electronic coupons database 111. Customer preferences database 113 may, but need not, be organized in the form of a customer preference table 200 as shown in FIG. 2. Likewise, vendor information database 109 may, but need not, be organized in the form of a vendor information table 300 as shown in FIG. 3, and electronic coupons database 111 may, but need not, be organized in the form of an electronic coupons table 400 as shown in FIG. 4.

FIG. 2 is a data structure diagram showing an exemplary customer preferences table 200 for use with the system of FIG. 1. A customer identifier 201 is any numeric, alphanumeric, or alphabetic identifier that uniquely identifies a specific customer. In the example of FIG. 2, actual customer names such as John Smith are used as customer identifiers, and an example of an alphanumeric customer identifier is presented as “B101”. Customer identifier 201 is associated with at least one endpoint device identifier 203, an optional customer geographic identifier 205, and at least one of a preferred vendor identifier 207, a preferred vendor category identifier 209, a preferred product/service identifier 211, or a preferred brand name identifier 215. Endpoint device identifier 203 specifies one or more characteristics of a customer endpoint device 101 (FIG. 1) used by a customer, such as the type or category of the endpoint device (i.e., personal computer versus wireless telephone), the media display capabilities of the device (i.e., audio only, still video, or full motion video), an internet protocol (IP) or global unique identifier (GUID) address used by the customer, or any of various combinations of the foregoing information. For example, if the customer uses a personal computer operatively coupled to a high-speed Internet connection, then endpoint device identifier 203 may include an IP address corresponding to the Internet connection, or an identifier indicative of the fact that customer endpoint device 101 is in the category of a personal computer.

Optional customer geographic identifier 205 includes geographic identifying indicia for a customer premises or a customer location. Geographic identifier 205 may include, for example, the street addresses and zip code for a customer premises, the latitude and longitude coordinates for the customer premises, X-Y coordinates for the customer premises, or any other variable which can be used to specify a location of a given customer premises.

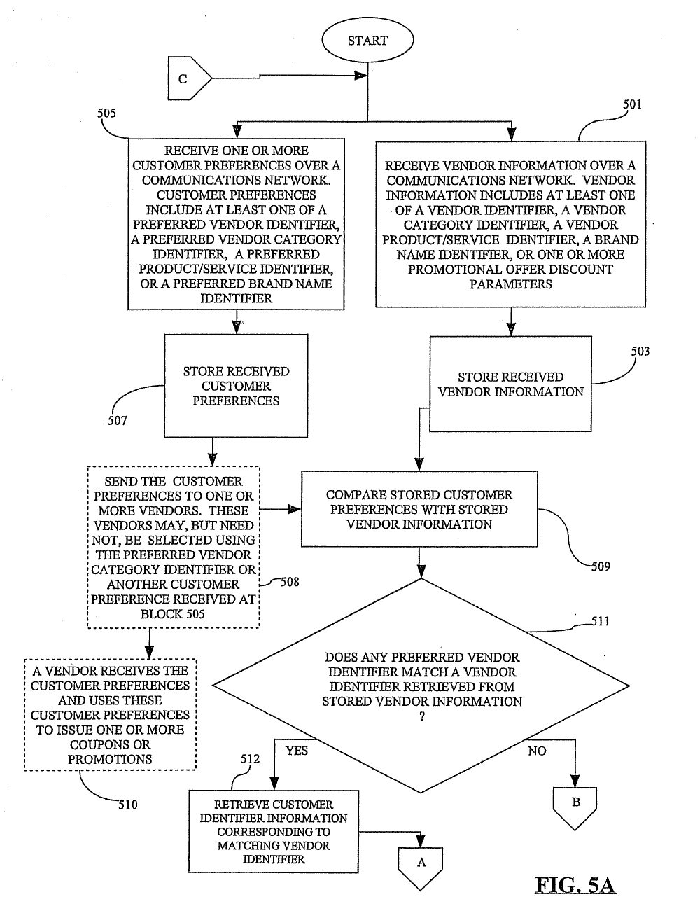

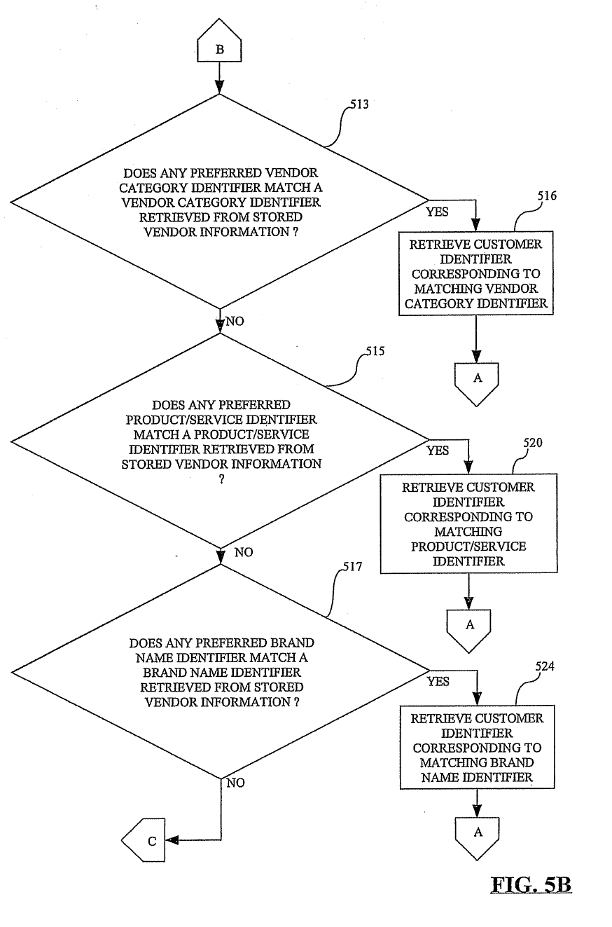

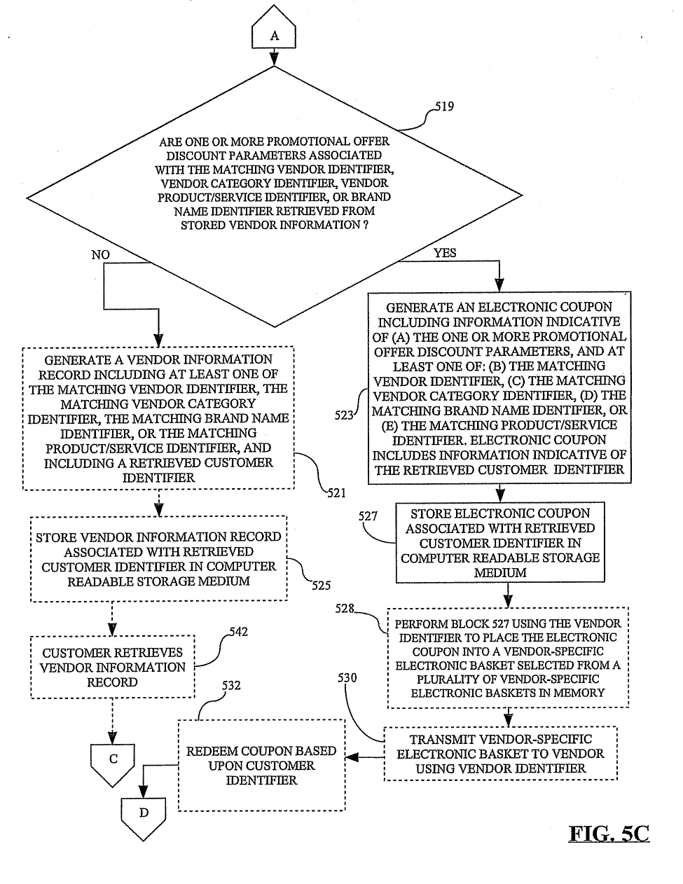

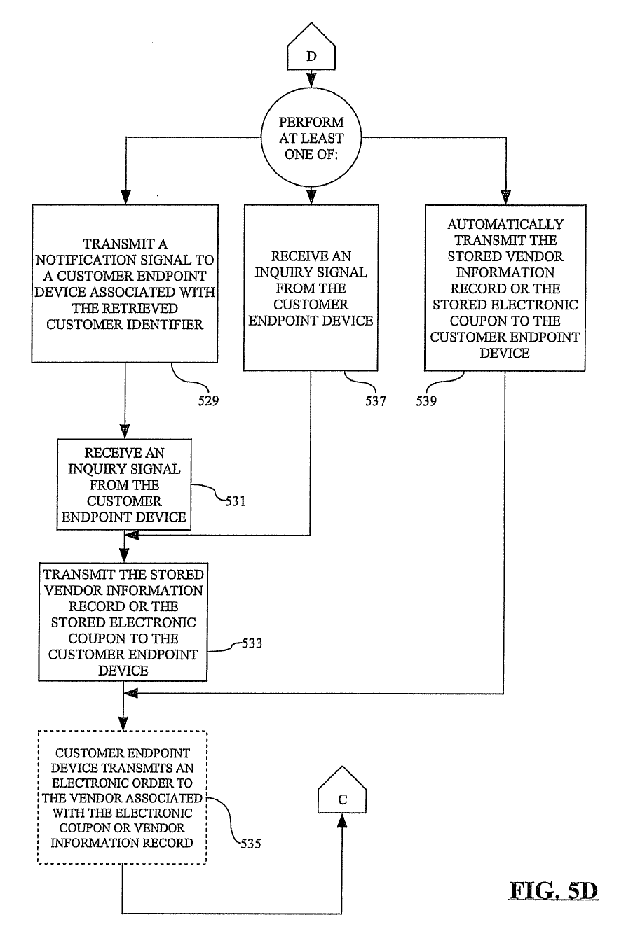

At least one of preferred vendor identifier 207, preferred vendor category identifier 209, preferred product/service identifier 211, or preferred brand name identifier 215 are selected or specified by a customer, as will be described in greater detail hereinafter with respect to FIGS. 5A-5D. Returning now to FIG. 2, preferred vendor identifier 207 is any numeric, alphanumeric, or alphabetic identifier that identifies a specific vendor. In the example of FIG. 2, actual vendor names such as “Home Depot”, “TJ Maxx”, and “Shop-Rite” are used as vendor identifiers, although this is not required. Preferred vendor category identifier 209 is any numeric, alphanumeric, or alphabetic identifier that identifies one or more subject matter categories pertaining to preferred vendor identifier 207. These subject matter categories may, but need not, be defined in terms of vendor type, such as home repair stores, discount stores, grocery stores, and electronic stores, for example.

Preferred product/service identifier 211 is any numeric, alphanumeric, or alphabetic identifier that identifies one or more categories of products or services offered by a vendor identified in a corresponding preferred vendor identifier 207. For instance, for a preferred vendor identifier of “Home Depot”, an illustrative product/service identifier 211 is “plumbing supplies”. In this example, product/service identifier 211 could optionally specify additional categories such as “electrical supplies”, “lumber”, and “garden supplies”. Preferred brand name identifier 215 is any numeric, alphanumeric, or alphabetic identifier that identifies one or more brand names offered by a vendor identified in a corresponding preferred vendor identifier 207 and related to subject matter set forth in a corresponding preferred product service identifier 211. For example, a preferred brand name identifier 215 corresponding to a preferred vendor identifier 207 of “Home Depot” and a preferred product/service identifier 211 of “plumbing supplies” may include Kohler and Moen. Optionally, the customer may specify a date or range of dates for which the customer plans to purchase a good or a service.

FIG. 3 is a data structure diagram showing an exemplary vendor information table 300 for use with the system of FIG. 1. A vendor identifier 307 is any numeric, alphanumeric, or alphabetic identifier that identifies a specific vendor. In the example of FIG. 3, actual vendor names such as “Home Depot”, “TJ Maxx”, and “Shop-Rite” are used as vendor identifiers, although this is not required. Vendor identifier 307 is associated with a vendor category identifier 309, an optional vendor geographic identifier 305, a vendor product/service identifier 311, a brand name identifier 315, an optional promotional offer product stock keeping unit (SKU) 317, an optional promotional offer discount parameter 319, and an optional promotional offer expiration date identifier 321.

Vendor category identifier 309 is any numeric, alphanumeric, or alphabetic identifier that identifies one or more subject matter categories pertaining to vendor identifier 309. These subject matter categories may, but need not, be defined in terms of vendor type, such as home repair stores, discount stores, grocery stores, and electronic stores, for example. Vendor product/service identifier 311 is any numeric, alphanumeric, or alphabetic identifier that identifies one or more categories of products or services offered by a vendor identified in a corresponding vendor identifier 307. For instance, for a preferred vendor identifier of “Home Depot”, an illustrative vendor product/service identifier 311 is “plumbing supplies”. In this example, vendor product/service identifier 311 could optionally specify additional categories such as “electrical supplies”, “lumber”, and “garden supplies”. Brand name identifier 315 is any numeric, alphanumeric, or alphabetic identifier that identifies one or more brand names offered by a vendor identified in a corresponding vendor identifier 307 and related to subject matter set forth in a corresponding vendor product service identifier 311. For example, a brand name identifier 315 corresponding to a vendor identifier 307 of “Home Depot” and a vendor product/service identifier 311 of “plumbing supplies” may specify a set of brand names carried by Home Depot, such as Kohler and Moen.

Promotional offer product stock keeping unit (SKU) 317 is an alphanumeric or numeric identifier assigned to a particular product that enables the product to be tracked for inventory purposes. Typically, unique SKU identifiers are assigned to each of a plurality of purchasable items in a catalog, store, or posted on e-commerce websites. SKUs are usually defined and established by vendors. Use of a promotional offer product SKU 317 is optional. In the example of FIG. 3, promotional offer SKU 317 is employed for the purpose of identifying items that are the subject of a promotional offer or coupon. Alternatively, other types of product or service identifiers in lieu of, or in addition to, SKU 317 may be employed.

Promotional offer discount parameter 319 specifies at least one of a discount amount, a discount percentage, or a selling price for an item identified in a corresponding promotional offer product SKU 317, for one or more items identified in a corresponding brand name identifier 315, or for one or more items offered for sale by a vendor identified in a corresponding vendor identifier 307. Illustratively, discount parameter 319 may be expressed as a percentage discount (15%), a selling price ($2999), or an amount to be subtracted from the selling price. Accordingly, discount parameter 319 is used to define the terms of a discount or incentive when this discount or incentive is to be offered to consumers in the form of an electronic coupon. Promotional offer expiration date identifier 321 specifies at least one of an expiration date or a period of validity corresponding to promotional offer discount parameter 319. Accordingly, promotional offer expiration date identifier 321 is used to specify the expiration date of an electronic coupon.

FIG. 4 is a data structure diagram showing an exemplary electronic coupons table 400 for use with the system of FIG. 1. For each of a plurality of electronic coupons, a customer identifier 401 is associated with a vendor identifier 407, a product/service identifier 411, a brand name identifier 415, a product SKU 417, a discount parameter 419, and an expiration date identifier 421. Customer identifier 401, obtained from customer identifier 201 of FIG. 2 as will be described in greater detail hereinafter, is any numeric, alphanumeric, or alphabetic identifier that uniquely identifies a specific customer. Vendor identifier 407 (FIG. 4), obtained from vendor identifier 307 (FIG. 3) as will be described in greater detail hereinafter, is any numeric, alphanumeric, or alphabetic identifier that identifies a specific vendor. Product/service identifier 411 (FIG. 4), obtained from vendor product/service identifier 311 (FIG. 3), is any numeric, alphanumeric, or alphabetic identifier that identifies one or more categories of products or services offered by a vendor identified in a corresponding vendor identifier 407 (FIG. 4).

Brand name identifier 415, obtained from brand name identifier 315 (FIG. 3), is any numeric, alphanumeric, or alphabetic identifier that identifies one or more brand names offered by a vendor identified in a corresponding vendor identifier 407 (FIG. 4) and related to subject matter set forth in a corresponding vendor product service identifier 411. Product SKU 417, discount parameter 419, and expiration date identifier 421 are defined as discussed above in connection with product SKU 317 (FIG. 3), discount parameter 319 and expiration date identifier 321, respectively. Expiration date identifier 421 can be used to automatically remove or disable expired electronic coupons from electronic coupons database 111 (FIG. 1), or to move expired electronic coupons from the electronic coupons database to an archival database or data warehouse. Individual horizontal rows of electronic coupons table 400 may each be conceptualized as comprising an electronic coupon.

FIGS. 5A-5D together comprise a flow diagram of an exemplary process for distributing electronic coupons. At block 505 (FIG. 5A), one or more customer preferences are received over a communications network. These customer preferences include at least one of a preferred vendor identifier 207 (FIG. 2), a preferred vendor category identifier 209, a preferred product/service identifier 211, or a preferred brand name identifier 215. At block 501 (FIG. 5A), vendor information is received over a communications network. Vendor information includes at least one of a vendor identifier 307 (FIG. 3), a vendor category identifier 309, a vendor product/service identifier 311, a brand name identifier 315, or one or more promotional offer discount parameters 319 and 321. Blocks 501 and 505 (FIG. 5A) may be performed simultaneously, contemporaneously, or in any order.

Program control advances from block 505 to block 507 where received customer preferences are stored in a computer-readable storage medium. Illustratively, received customer preferences are stored in the form of a customer preferences table 200 (FIG. 2) discussed previously. At optional block 508, the customer preferences received at block 505 are sent to one or more vendors. These vendors may, but need not, be selected based upon customer preferences that were received at block 505, such as the preferred vendor category or another received customer preference. The program then advances to block 509 or optional block 510 or both. Block 509 will be described in greater detail hereinafter. At optional block 510, a vendor receives the customer preferences and uses these customer preferences to issue one or more coupons or promotions.

From block 501 (FIG. 5A), program control advances to block 503 where received vendor information is stored in a computer-readable storage medium. Illustratively, received vendor information is stored in the form of a vendor information table 300 (FIG. 3) discussed previously. Note that blocks 501 and 503 (FIG. 5A) may be executed one or more times for each of a plurality of vendors, and that blocks 505 and 507 may be executed one or more times for each of a plurality of customer preferences.

From block 503, block 507, or optional block 508, program control advances to block 509 where stored customer preferences (refer to FIG. 2) are compared with stored vendor information (refer to FIG. 3). Block 509 (FIG. 5A) may be performed once, repeatedly, at periodic or prescheduled intervals, in response to a receipt of new vendor information at block 501, in response to a receipt of new customer preferences at block 505, or in accordance with various combinations of the aforementioned performance times. Next, at block 511, a test is performed to ascertain whether or not any preferred vendor identifier matches a vendor identifier retrieved from the stored vendor information. If so, the customer identifier corresponding to the matching vendor identifier is retrieved (block 512), and the program advances to block 519 (FIG. 5C). Block 519 is described in greater detail hereinafter.

The negative branch from block 511 (FIG. 5A) leads to block 513 (FIG. 5B) where a test is performed to ascertain whether or not any preferred vendor category identifier matches a vendor category identifier retrieved from the stored vendor information. If so, the customer identifier corresponding to the matching vendor category identifier is retrieved (block 516), and the program advances to block 519 (FIG. 5C) (described hereinafter).

The negative branch from block 513 (FIG. 5B) leads to block 515 where a test is performed to ascertain whether or not any preferred product/service identifier matches a product/service identifier retrieved from the stored vendor information. If so, the customer identifier corresponding to the matching product/service information is retrieved (block 520), and the program advances to block 519 (FIG. 5C) (described hereinafter).

The negative branch from block 515 (FIG. 5B) leads to block 517 where a test is performed to ascertain whether or not any preferred brand name identifier matches a brand name identifier retrieved from the stored vendor information. If so, the customer identifier corresponding to the matching brand name identifier is retrieved (block 524), and the program advances to block 519 (FIG. 5C) (described hereinafter). The negative branch from block 517 leads back to blocks 501 and 505 (FIG. 5A) described previously.

At block 519 (FIG. 5C), a test is performed to ascertain whether or not one or more promotional offer discount parameters are associated with the matching vendor identifier, vendor category identifier, vendor product/service identifier, or brand name identifier retrieved from the stored vendor information. If not, a vendor information record is optionally generated at block 521. The vendor information record may include the retrieved customer identifier (FIGS. 5A and 5B, blocks 512, 516, 520, 524) and at least one of the matching vendor identifier, the matching vendor category identifier, the matching brand name identifier, the matching product/service identifier, or the price of a product/service. Next, at optional block 525 (FIG. 5C), the vendor information record associated with the retrieved customer identifier is stored in a computer readable storage medium. At optional block 542, the customer retrieves the vendor information record, and the program then loops back to blocks 501 and 505 of FIG. 5A.

The affirmative branch from block 519 (FIG. 5C) leads to block 523. At block 523 (FIG. 5C), an electronic coupon is generated. The electronic coupon includes information indicative of one or more promotional offer discount parameters, information indicative of at least one of (a) the matching vendor identifier, (b) the matching vendor category identifier, (c) the matching brand name identifier, or (d) the matching product/service identifier; and, includes information indicative of the retrieved customer identifier (FIGS. 5A and 5B, blocks 512, 516, 520, 524). Next, at block 527 (FIG. 5C), the electronic coupon associated with the retrieved customer identifier is stored in a computer-readable storage medium. At optional block 528, the storage step described in block 527 is performed by using the vendor identifier to place the electronic coupon into a vendor-specific electronic basket selected from a plurality of vendor-specific electronic baskets in memory. At optional block 530, the vendor-specific electronic basket is transmitted to a vendor using the vendor identifier of block 527. Then, at optional block 532, a coupon from the vendor-specific electronic basket is redeemed based upon the customer identifier.

After block 527 or optional block 532 has been performed, the program then progress to at least one of blocks 529, 537, or 539 (FIG. 5D). Selection of block 529, 537, or 539 is an implementational detail that may be performed in accordance with the requirements or objectives of specific real-world applications. If more than one of blocks 529, 537 and 539 are performed, the blocks may be performed simultaneously, contemporaneously, repeatedly, in any order, or in any of various combinations thereof At block 529, a notification signal is transmitted to a customer endpoint device 101 (FIG. 1) associated with the retrieved customer identifier (FIGS. 5A-5B, blocks 512, 516, 520, 524). Illustratively, this customer endpoint device 101 (FIG. 1) is specified in the form of endpoint device identifier 203 (FIG. 2) of customer preferences table 200. The program progresses to block 531 (FIG. 5D) where an inquiry signal is received from the customer endpoint device. Program control then proceeds to block 533, to be described in greater detail hereinafter.

At block 537, an inquiry signal is received from customer endpoint device 101 (FIG. 1). The program then advances to block 533 (FIG. 5D), to be described hereinafter. At block 539, the stored vendor information record or stored electronic coupon is automatically transmitted to customer endpoint device 101 (FIG. 1). Optionally, at block 535 (FIG. 5D), the customer endpoint device transmits an electronic order to the vendor associated with the electronic coupon or vendor information record. The program then loops back to any of blocks 501 and 505 (FIG. 5A).

Block 533 (FIG. 5D) is performed after execution of block 531 or block 537. At block 533, the stored vendor information record or the stored electronic coupon is transmitted to customer endpoint device 101 (FIG. 1). The program then advances to optional block 535 (discussed previously).

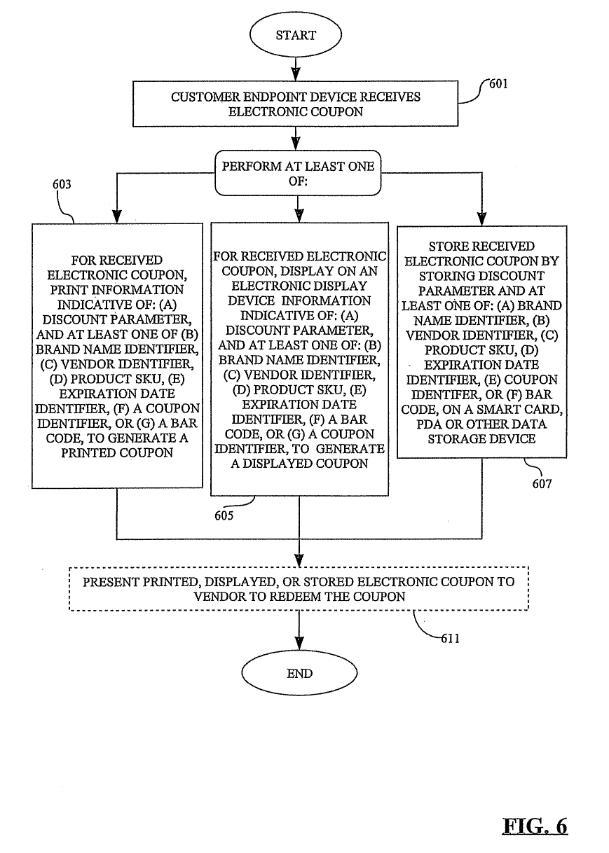

FIG. 6 is a flow diagram of an exemplary process for receiving and storing electronic coupons. The program commences at block 601 where customer endpoint device 101 (FIG. 1) receives an electronic coupon. Illustratively, the electronic coupon is received from electronic promotion distribution server 107 using at least one of communications network 105, smart card 153, or magnetic strip card 151. Returning to FIG. 6, one or more of blocks 603, 605, or 607 are performed. Selection of block 603, 605, or 607 is an implementational detail that may be performed in accordance with the requirements or objectives of specific real-world applications. If more than one of blocks 603, 605 and 607 are performed, the blocks may be performed simultaneously, contemporaneously, repeatedly, in any order, or in any of various combinations thereof

At block 603, for a received electronic coupon, information is printed that is indicative of (a) a discount parameter 419 (FIG. 4), and at least one of: (b) a brand name identifier 415, (c) a vendor identifier 407, (d) a product SKU 417, (e) an expiration date identifier 421, (f) a coupon identifier that identifies a coupon, or (g) a bar code corresponding to the electronic coupon, to generate a printed coupon. If the printed coupon includes a bar code corresponding to the electronic coupon, this bar code could, but need not, be provided in the form of a product SKU 417, in which case product SKU 417 may, but need not, be implemented in the form of a universal product code (UPC). Optionally, the printed coupon is presented to a vendor (FIG. 6, block 611).

At block 605, for a received electronic coupon, information indicative of (a) a discount parameter 419 (FIG. 4) and at least one of: (b) a brand name identifier 415, (c) a vendor identifier 407, (d) a product SKU 417, (e) an expiration date identifier 421, (f) a bar code corresponding to the electronic coupon, or (g) a coupon identifier that identifies a coupon, is displayed to generate an electronically displayed coupon. If the displayed coupon includes a bar code corresponding to the electronic coupon, this bar code could, but need not, be provided in the form of a product SKU 417, in which case product SKU 417 may, but need not, be implemented in the form of a universal product code (UPC). Optionally, the displayed coupon is presented to a vendor (FIG. 6, block 611).

At block 607, a received electronic coupon is stored by storing a discount parameter 419 (FIG. 4), and at least one of: (a) a brand name identifier 415, (b) a vendor identifier 407, (c) a product SKU 417, (d) an expiration date identifier 421, (e) a coupon identifier that identifies a coupon, or (f) a bar code. If the stored coupon includes a bar code corresponding to the electronic coupon, this bar code could, but need not, be provided in the form of a product SKU 417, in which case product SKU 417 may, but need not, be implemented in the form of a universal product code (UPC). The electronic coupon is stored on a smart card, PDA, magnetic strip card, memory stick, floppy disk, CD-ROM, or other data storage device. Next, at optional block 611 (FIG. 6), the stored coupon is presented to a vendor for redemption.

As described heretofore, the exemplary embodiments can be provided in the form of computer-implemented processes and apparatuses for practicing those processes. The exemplary embodiments can also be provided in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be provided in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the exemplary embodiments. When implemented on a general-purpose microprocessor, the computer program code segments execute specific microprocessor machine instructions. The computer program code could be implemented using electronic logic circuits or a microchip.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for distributing electronic coupons including:
receiving customer preferences including a customer identifier associated with at least one of a preferred vendor identifier, a preferred vendor category identifier, a preferred product/service identifier, or a preferred brand name identifier;
receiving vendor information including at least one of a vendor identifier, a vendor category identifier, a vendor product/service identifier, a brand name identifier, or a promotional offer discount parameter;
comparing the customer preferences with the vendor information to determine whether or not a match exists between the customer preferences and the vendor information, and if a match exists:
generating an electronic coupon including information indicative of at least one of the preferred vendor identifier, the preferred vendor category identifier, the preferred product/service identifier, the preferred brand name identifier, or the promotional offer discount parameter.

2. The method of claim 1 wherein a match exists if at least one of: (i) a preferred vendor identifier matches a vendor identifier from the vendor information, thus providing a matching vendor identifier; (ii) a preferred vendor category identifier matches a vendor category identifier from the vendor information, thus providing a matching vendor category identifier; (iii) a preferred product/service identifier matches a product/service identifier from the vendor information, thus providing a matching product/service identifier; or (iv) a preferred brand name identifier matches a brand name identifier from the vendor information, thus providing a matching brand name identifier.

3. The method of claim 1 further including storing the received vendor information and the received customer preferences in a computer-readable storage medium.

4. The method of claim 3 further including retrieving from the computer-readable storage medium a received customer identifier associated with at least one of the matching vendor identifier, the matching preferred vendor category identifier, the matching preferred product/service identifier, or the matching preferred brand name identifier.

5. The method of claim 4 further including associating the electronic coupon with the retrieved customer identifier, and at least one of: transmitting the generated electronic coupon over a communications network, storing the generated electronic coupon in a smart card, or storing the generated electronic coupon in a card equipped with a magnetic stripe.

6. The method of claim 5 further including receiving the generated electronic coupon and at least one of: storing the generated electronic coupon in an electronic memory device, storing the generated electronic coupon in a smart card, storing the generated electronic coupon in a magnetic stripe card, or printing the generated electronic coupon.

7. The method of claim 6 further including using the preferred vendor identifier to store the electronic coupon in a vendor-specific electronic basket selected from a plurality of vendor-specific electronic baskets in the electronic memory device.

8. The method of claim 7 further including transmitting one or more electronic coupons stored in the vendor-specific electronic basket to a vendor identified by the preferred vendor identifier.

9. The method of claim 8 further including redeeming one or more electronic coupons stored in the vendor-specific electronic basket based upon the customer identifier.

10. The method of claim 1 further including sending the received customer preferences to one or more vendors based upon receiving from a customer at least one of: (a) a preferred vendor identifier, (b) a preferred vendor category identifier, (c) a preferred product/service identifier, or (d) a preferred brand name identifier.

11. The method of claim 10 further including a vendor receiving the customer preferences and using the customer preferences to issue one or more coupons or promotions.

12. The method of claim 1 further including transmitting the generated electronic coupon to at least one vendor based upon at least one of (a) a preferred vendor identifier, (b) a preferred vendor category identifier, (c) a preferred product/service identifier, or (d) a preferred brand name identifier.

13. A computer program product comprising a storage medium readable by a processing circuit and storing instructions for execution by the processing circuit for facilitating a method of distributing electronic coupons, the method comprising:
receiving customer preferences including a customer identifier associated with at least one of a preferred vendor identifier, a preferred vendor category identifier, a preferred product/service identifier, or a preferred brand name identifier;
receiving vendor information including at least one of a vendor identifier, a vendor category identifier, a vendor product/service identifier, a brand name identifier, or a promotional offer discount parameter;
comparing the customer preferences with the vendor information to determine whether or not a match exists between the customer preferences and the vendor information, and if a match exists:
generating an electronic coupon including information indicative of at least one of the preferred vendor identifier, the preferred vendor category identifier, the preferred product/service identifier, the preferred brand name identifier, or the promotional offer discount parameter.

14. The computer program product of claim 13 wherein a match exists if at least one of: (i) a preferred vendor identifier matches a vendor identifier from the vendor information, thus providing a matching vendor identifier; (ii) a preferred vendor category identifier matches a vendor category identifier from the vendor information, thus providing a matching vendor category identifier; (iii) a preferred product/service identifier matches a product/service identifier from the vendor information, thus providing a matching product/service identifier; or (iv) a preferred brand name identifier matches a brand name identifier from the vendor information, thus providing a matching brand name identifier.

15. The computer program product of claim 13 further including instructions for storing the received vendor information and the received customer preferences in a computer-readable storage medium.

16. The computer program product of claim 15 further including instructions for retrieving from the computer-readable storage medium a received customer identifier associated with at least one of the matching vendor identifier, the matching preferred vendor category identifier, the matching preferred product/service identifier, or the matching preferred brand name identifier.

17. The computer program product of claim 16 further including instructions for associating the electronic coupon with the retrieved customer identifier, and at least one of: transmitting the generated electronic coupon over a communications network, storing the generated electronic coupon in a smart card, or storing the generated electronic coupon in a card equipped with a magnetic stripe.

18. The computer program product of claim 17 further including instructions for receiving the generated electronic coupon, and at least one of: storing the generated electronic coupon in an electronic memory device, storing the generated electronic coupon in a smart card, storing the generated electronic coupon in a magnetic stripe card, or printing the generated electronic coupon.

19. The computer program product of claim 18 further including instructions for using the preferred vendor identifier to store the electronic coupon in a vendor-specific electronic basket selected from a plurality of vendor-specific electronic baskets in the electronic memory device.

20. The computer program product of claim 19 further including instructions for transmitting one or more electronic coupons stored in the vendor-specific electronic basket to a vendor identified by the preferred vendor identifier.

21. The computer program product of claim 20 further including instructions for redeeming one or more electronic coupons stored in the vendor-specific electronic basket based upon the customer identifier.

22. The computer program product of claim 13 further including instructions for sending the received customer preferences to one or more vendors based upon receiving from a customer at least one of: (a) a preferred vendor identifier, (b) a preferred vendor category identifier, (c) a preferred product/service identifier, or (d) a preferred brand name identifier.

23. The computer program product of claim 22 further including instructions for facilitating a vendor receiving the customer preferences and using the customer preferences to issue one or more coupons or promotions.

24. The computer program product of claim 13 further including instructions for transmitting the generated electronic coupon to at least one vendor based upon at least one of: (a) a preferred vendor identifier, (b) a preferred vendor category identifier, (c) a preferred product/service identifier, or (d) a preferred brand name identifier.

25. A device or group of devices for receiving and storing electronic coupons, the device or group of devices including:
an input mechanism for specifying customer preferences including at least one of a preferred vendor identifier, a preferred vendor category identifier, a preferred product/service identifier, or a preferred brand name identifier;
a communications mechanism, operatively coupled to the input mechanism, for transmitting the specified customer preferences to a communications network, and for receiving at least one electronic coupon from the communications network, the electronic coupon including at least one of the preferred vendor identifier, the preferred vendor category identifier, the preferred brand name identifier, or a promotional offer discount parameter;
a computer-readable storage mechanism;
a processing mechanism, operatively coupled to the communications mechanism and to the computer-readable storage mechanism, for storing the electronic coupon in the computer-readable storage medium; and
an output mechanism, operatively coupled to the processing mechanism, for performing at least one of: (a) electronically displaying information indicative of at least one of the preferred vendor identifier, the preferred vendor category identifier, the preferred brand name identifier, or the promotional offer discount parameter, (b) outputting the electronic coupon to a data communications port, or (c) generating a printout indicative of at least one of the preferred vendor identifier, the preferred vendor category identifier, the preferred brand name identifier, or the promotional offer discount parameter.

26. The device or group of devices of claim 25 further including at least one of a smart card reader/writer or a magnetic strip reader/writer for producing electronic coupons.

27. The device or group of devices of claim 25 wherein the communications mechanism is capable of transmitting the specified customer preferences to one or more vendors based upon receiving from a customer at least one of: (a) a preferred vendor identifier, (b) a preferred vendor category identifier, (c) a preferred product/service identifier, or (d) a preferred brand name identifier.

28. The device or group of devices of claim 27 wherein the communications mechanism is capable of transmitting the generated electronic coupon to at least one vendor based upon at least one of (a) a preferred vendor identifier, (b) a preferred vendor category identifier, (c) a preferred product/service identifier, or (d) a preferred brand name identifier.

29. The device or group of devices of claim 25 wherein the computer-readable storage mechanism includes a plurality of vendor-specific electronic baskets, and the processing mechanism uses the preferred vendor identifier to store the electronic coupon in a vendor-specific electronic basket selected from the plurality of vendor-specific electronic baskets.

30. The device or group of devices of claim 29 wherein the communications mechanism is capable of transmitting one or more electronic coupons stored in the vendor-specific electronic basket to a vendor identified by the preferred vendor identifier.

31. The device or group of devices of claim 29 wherein one or more electronic coupons stored in the vendor-specific electronic basket are redeemed based upon the customer identifier.

32. A system for distributing electronic coupons including:
a receiving mechanism for receiving customer preferences including a customer identifier associated with at least one of a preferred vendor identifier, a preferred vendor category identifier, a preferred product/service identifier, or a preferred brand name identifier;
wherein the receiving mechanism is capable of receiving vendor information including at least one of a vendor identifier, a vendor category identifier, a vendor product/service identifier, a brand name identifier, or a promotional offer discount parameter;
a processing mechanism capable of comparing the customer preferences with the vendor information to determine whether or not a match exists between the customer preferences and the vendor information, and if a match exists, the processing mechanism generating an electronic coupon including information indicative of at least one of the preferred vendor identifier, the preferred vendor category identifier, the preferred product/service identifier, the preferred brand name identifier, or the promotional offer discount parameter.

33. The system of claim 32 wherein the processing mechanism is programmed to determine that a match exists if at least one of: (i) a preferred vendor identifier matches a vendor identifier from the vendor information, thus providing a matching vendor identifier; (ii) a preferred vendor category identifier matches a vendor category identifier from the vendor information, thus providing a matching vendor category identifier; (iii) a preferred product/service identifier matches a product/service identifier from the vendor information, thus providing a matching product/service identifier; or (iv) a preferred brand name identifier matches a brand name identifier from the vendor information, thus providing a matching brand name identifier.

34. The system of claim 33 further including a computer-readable storage medium capable of storing the received vendor information and the received customer preferences.

35. The system of claim 34 wherein the processing mechanism is programmed to retrieve from the computer-readable storage medium a received customer identifier associated with at least one of the matching vendor identifier, the matching preferred vendor category identifier, the matching preferred product/service identifier, or the matching preferred brand name identifier.

36. The system of claim 35 wherein the processing mechanism is programmed to associate the electronic coupon with the retrieved customer identifier.

37. The system of claim 36 further including a mechanism for at least one of: transmitting the generated electronic coupon over a communications network, storing the generated electronic coupon in a smart card, or storing the generated electronic coupon in a card equipped with a magnetic stripe.

38. The system of claim 37 further including a customer device or group of devices equipped with a customer device processing mechanism capable of receiving the generated electronic coupon over the communications network, and capable of at least one of: storing the generated electronic coupon in an electronic memory device, storing the generated electronic coupon in a smart card, storing the generated electronic coupon in a magnetic stripe card, or initiating a printing of the generated electronic coupon.

39. The system of claim 38 wherein the customer device processing mechanism uses the preferred vendor identifier to store the electronic coupon in a vendor-specific electronic basket selected from a plurality of vendor-specific electronic baskets in the electronic memory device.

40. The system of claim 39 wherein the customer device processing mechanism is capable of transmitting one or more electronic coupons stored in the vendor-specific electronic basket to a vendor identified by the preferred vendor identifier.

41. The system of claim 40 wherein the customer device processing mechanism is programmed to redeem one or more electronic coupons stored in the vendor-specific electronic basket based upon the customer identifier.

42. The system of claim 32 wherein the transmitting mechanism is capable of transmitting the received customer preferences to one or more vendors based upon receiving from a customer at least one of: (a) a preferred vendor identifier, (b) a preferred vendor category identifier, (c) a preferred product/service identifier, or (d) a preferred brand name identifier.

43. The system of claim 42 further including a vendor communications and processing mechanism for receiving the customer preferences and using the customer preferences to issue one or more coupons or promotions.

44. The system of claim 32 wherein the transmitting mechanism is capable of transmitting the generated electronic coupon to at least one vendor based upon at least one of (a) a preferred vendor identifier, (b) a preferred vendor category identifier, (c) a preferred product/service identifier, or (d) a preferred brand name identifier.
